(19) United States
(12) Patent Application Publication
(10) Pub. No.: US 2014/0258122 A1
(43) Pub. Date: Sep. 11, 2014

(54) FRAUD DETECTION BASED ON AGE OF CONTACT INFORMATION

(71) Applicants: Brad Wardman, Phoenix, AZ (US); Jeremy Pickett, Scottsdale, AZ (US)

(72) Inventors: Brad Wardman, Phoenix, AZ (US); Jeremy Pickett, Scottsdale, AZ (US)

(21) Appl. No.: 13/794,062

(22) Filed: Mar. 11, 2013

(51) Int. Cl. G06Q 40/02

(52) U.S. Cl. CPC G06Q 40/02
USPC 705/44; 705/35; 705/39

(57) ABSTRACT

Systems and methods for determining trustworthiness of a user are described. The methods include receiving information provided by the user to set up a new financial account, extracting contact information from the received information, transmitting the contact information to a third party to determine an age of the contact information, receiving the age of the contact information, and based on the age, assigning a confidence metric, wherein the confidence metric is associated with the trustworthiness of the user.

### BACKGROUND

1. Field of the Invention

The present invention generally relates to identifying account fraud, and specifically to detecting new account fraud.

2. Related Art

Numerous businesses, such as financial institutions, department stores, businesses, on-line businesses, and businesses making sales over the telephone face the challenge of protecting the business from customers attempting to defraud it. These businesses regularly handle thousands of accounts from its users or consumers. Such accounts may include instant credit or credit accounts with a department store or other retail outlet, or accounts involving checks, credit cards, debit cards, or ATM cards of a bank, credit or other financial institution.

Identity theft may include account takeover, where a thief steals the identity of an individual and then uses that information to take over ownership of that individual's account, or it may involve new account fraud, wherein the identity thief uses stolen information to open new accounts in another person's name.

Conventional methods for detecting identity theft can be problematic. Typically, to detect fraud, businesses have used databases of known fraud addresses, emails, and/or telephone numbers and compared the contact information they receive with this known information. This method is useful only if there is known negative information. Fraudsters, however, often use new contact information to set up new accounts.

Thus, it is desirable to provide methods and systems that can assess the risk of fraud in new financial accounts.

### BRIEF DESCRIPTION OF THE FIGURES

FIG. 1 is a block diagram of a networked system suitable for implementing the methods described herein according to an embodiment;

FIG. 2 is a flowchart showing a method for determining trustworthiness of a user according to an embodiment; and

FIG. 3 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for detecting fraud in new financial account requests. When a new financial account is opened, contact information (e.g., email address, home phone number, work phone number, cell phone number, etc.) is provided by the user and then extracted from the other information received. The age of the contact information is determined, and based on the age of the contact information, a confidence metric is assigned to the contact information. The confidence metric is then used to determine the honesty and trustworthiness of the user, which can in turn be used to determine the scope of transactions that are allowed with the financial account. The present disclosure uses the age of the contact information to identify potential and suspicious identity fraud events. As a further layer of security, the level or amount of interaction the user has with one or more of his or her accounts or contact points (e.g., email accounts, phone accounts, financial accounts, etc.) may be determined.

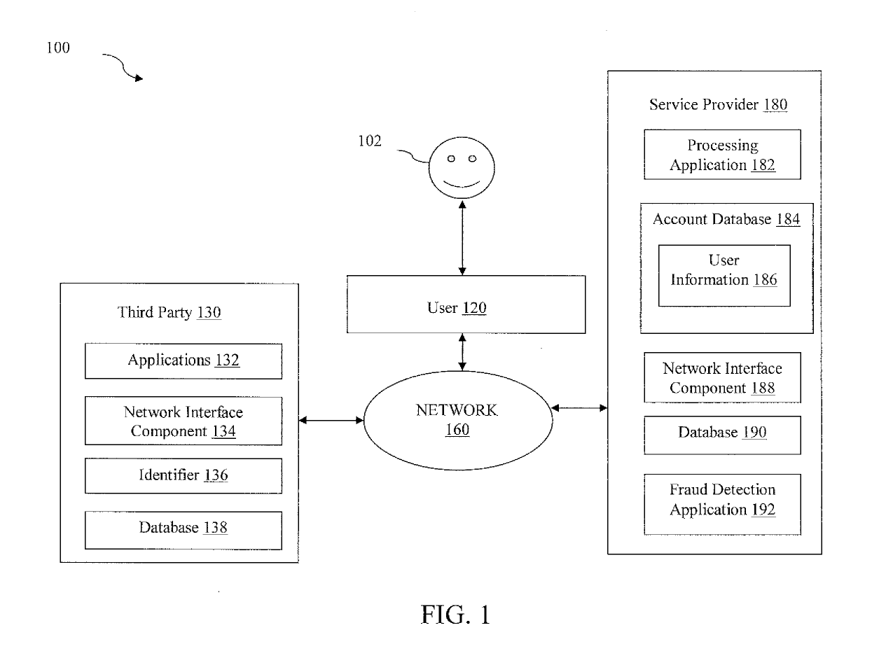

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities. As shown in FIG. 1, the system 100 includes a user device 120, a third party server 130, and a service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet. As such, in various embodiments, a user device 120, a third party server 130, and a service provider server 180 may be associated with a particular link (e.g., a link, such as a URL (Uniform Resource Locator) to an IP (Internet Protocol) address).

The user device 120, in one embodiment, may be utilized by the user 102 to interact with the third party server 130 and/or the service provider server 180 over the network 160. For example, the user 102 may create an email and/or phone account with the third party server 130 or may conduct financial transactions (e.g., account transfers) with the service provider server 180 via the user device 120. In various implementations, the user device 120 includes a wireless telephone (e.g., cellular or mobile phone), a tablet, a personal digital assistant (PDA), a personal computer, a notebook computer, and/or various other generally known types of wired and/or wireless computing devices.

In various implementations, a user profile may be created using data and information obtained from activity of the user 102 over the network 160. For example, cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include a user identifier as one or more attributes related to the user 102, such as personal information (e.g., a user name, password, photograph image, biometric id, address, social security number, phone number, email address, etc.) and banking information (e.g., banking institution, credit card issuer, user account numbers, security information, etc.). In various implementations, the user identifier may be passed with network traffic data of the user 102 to the service provider server 180, and the user identifier may be used by the service provider server 180 to associate the user 102 with a user account maintained by the service provider server 180.

In various implementations, the user 102 is able to input data and information into an input component (e.g., a keyboard) of the user device 120 to provide user information with a transaction request, such as a fund transfer request. The user information may include user identification information.

The third party server 130, in various embodiments, may be implemented using any appropriate combination of hardware and/or software configured for wired and/or wireless communication over the network 160. The third party server 130, in various embodiments, may include one or more applications 132 to provide features to the user 102. For example, these applications 132 may include security applications for implementing client-side security features, programmatic client applications for interfacing with appropriate application programming interfaces (APIs) over the network 160 or various other types of generally known programs and/or applications.

The third party server 130, in one embodiment, may include at least one network interface component (NIC) 134 adapted to communicate with the network 160. In various examples, the network interface component 134 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The third party server 130, in one embodiment, may include one or more identifiers 136, which may be implemented as operating system registry entries, identifiers associated with hardware of the third party server 130, and/or various other appropriate identifiers. The identifier 136 may include attributes related to the third party server 130, such as identification information (e.g., a serial number, a location address, Global Positioning System (GPS) coordinates, a network identification number, etc.) and network information (e.g., network owner, network provider, network administrator, network security information, etc.). In various implementations, the identifier 136 may be passed with network traffic data and information to the service provider server 180, and the identifier 136 may be used by the service provider server 180 to associate one or more network transactions of the user 102 with one or more particular user accounts maintained by the service provider server 180.

In one embodiment, the third party server 130 is operated by an email service provider, such as Hotmail, Yahoo, Google, Excite, Snap, Altavista, or Lycos. The user 102 creates an email address through the email service provider, and the email service provider sends, receives, and stores email for the user 102. In another embodiment, the third party server 130 is operated by a phone service provider, such as AT&T, Verizon, Comcast, Time Warner, Sprint, or T-Mobile. The user 102 is assigned a phone number by the phone service provider, and the phone service provider allows the user 102 to make and receive calls. The third party server 130, in either embodiment, can determine the date the email address and/or phone number was created, how long this contact information has been associated with the user 102, how often the user 102 has logged into the account, and how many emails and/or phone calls the account has received.

The third party server, in various embodiments, includes a database 138 for storing information regarding a plurality of users, including user 102. The information can include, for example, contact information of the user 102, including email addresses, home addresses, phone numbers, etc.

The service provider server 180, in various embodiments, may be maintained by an online service provider, which is adapted to provide processing for financial transactions on behalf of the user 102. The service provider server 180 includes at least one processing application 182, which may be adapted to interact with the user device 120 via the network 160 to facilitate financial transactions. In one example, the service provider server 180 may be provided by PayPal, Inc. of San Jose, Calif., USA.

The service provider server 180, in one embodiment, may be configured to maintain a plurality of user accounts in an account database 184, each of which may include account information 186 associated with individual users, including the user 102. For example, account information 186 may include balance information, payment information, fund transfer information, deposit information, etc. In another example, account information 186 may include identification information and/or private financial information of the user 102, such as account numbers, identifiers, passwords, phone numbers, credit card information, banking information, or other types of financial information, which may be used to facilitate online transactions between the user 102 and the service provider server 180. It should be appreciated that the methods and systems described herein may be modified to accommodate users that may or may not be associated with at least one existing user account.

The service provider server 180, in various embodiments, may include at least one network interface component (NIC) 188 adapted to communicate with the network 160 including the network interface component 134 of the third party server 130 and the user device 120. In various implementations, the network interface component 188 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal and/or external databases) for storing and tracking information related to financial transactions between particular users, such as the user 102, and the service provider server 180. For example, the databases 190 may provide a historical survey of financial transactions between the user 102 and the service provider 180. As such, in one implementation, the processing application 182 may be configured to track, log, store, and access financial transaction information and provide this information to the processing application 182 for analysis and maintenance.

The database 190 may also store, for example, address data for calling the user device 120. The address data may include data for communicating a text message to the user device 120, an email address at which messages are receivable by the user device 120, or any other manner for communicating with the user device 120 so as to enable the communication to be provided to the user 102 during the conduct of a particular transaction. Moreover, service provider server 180 may include computer executable instructions that are operative to cause the server 180 to generate message content appropriate for messages to be communicated to the user device 120.

The service provider server 180, in various embodiments, also includes a fraud detection application 192, which may be adapted to interact with the third party server 130 via the network 160 to facilitate the detection of suspicious new financial accounts. When a new account is created, the user 102 enters various information, including contact information. Fraud detection application 192 extracts the contact information (e.g., email address and/or phone number) and transmits the contact information to the third party server 130. The third party server 130 takes the contact information, queries its database(s) and determines the age of the contact information. The third party server 130 transmits the age of the contact information to the service provider server 180 in any suitable way, including, but not limited to Secure File Transfer Protocol (SFTP), API calls, etc. The service provider server 180 then assigns a confidence metric to the contact information.

In certain embodiments, the third party server 130 also determines the level of interaction the user 102 has with his or her email and/or phone accounts and transmits this information to the service provider server 180. For example, the third party server 130 queries its database(s) to determine how many calls were made and received, how long the calls were, how many emails were sent and received, how many times the user 102 has logged into the account, how long the user 102 is logged in, etc. The service provider server 180 receives this information and uses it as another factor in determining the trustworthiness of the user 102.

In other embodiments, the service provider server 180 determines the level of interaction the user 102 has with his or her financial account. For example, the service provider server 180 questions its database(s) to determine what kinds of financial transactions the user 102 has performed, how often the user 102 has used his or her account, the dollar amount on the financial transactions the user 102 has performed, etc. The service provider server 180 can then use this information to further assess the trustworthiness of the user 102.

The higher the level of interaction the user 102 has had with the account(s), the more likely that the user 102 is not a fraudster. Fraudsters typically have little to no interaction with the accounts they set up to commit fraud. The accounts exist mainly for the purpose of committing identity theft, rather than for any legitimate purpose.

In various embodiments, the third party server 130, the user device 120 and the service provider server 180 may be associated with a particular link (e.g., a link, such as a URL (Uniform Resource Locator) to an IP (Internet Protocol) address). In this regard, the user 102 may interface with the third party server 130 and/or the user device 120 via the network 160 to facilitate financial transactions with the service provider server 180.

“Identity theft,” as used herein, refers to the misappropriation of any confidential information, such as information related to identity. Examples of information related to identity include a user name, a password, a financial identifier such as a credit card number or bank account number, a social security number, a driver's license number, medical information, and personal information such as a mother's maiden name, birthday or place of birth.

In new account fraud, fraudsters attempt to establish a new account that can be used to facilitate fraudulent activities. Fraudsters may have many sets of identity information for use in establishing new accounts. Generally, in new account fraud, the fraudster calls the financial institution, or sets up a new financial account online. The fraudster steals or otherwise gains access to identity information of another person (e.g., a legitimate customer) to subsequently use the identity information to establish the new account, but directs communication to an address, email address, or phone number used by the fraudster. A fraudster may illegally obtain information regarding a consumer by mail theft and may attempt to open an account using personally identifiable information of the consumer included in the mail. The most common type of new account fraud by identity thieves is the opening of credit lines.

New financial accounts (e.g., credit card, debit card, bank account, etc.) can be created relatively easily online or on the phone. Creditors issue credit on three key pieces of information, including a valid name, an address, and a social security number. In some cases, a phone number and/or email address may also be requested. No identification is checked, and approval of the new account can be obtained almost immediately.

Generally, a user is issued credit after an account has been approved by an issuer system such as a financial institution (bank) or other organization. The issuer system registers the user, issues a card(s), and operates a card account to which payments can be charged. The user is able to make purchases with the card for products and/or services from a merchant accepting the card up to a pre-established credit limit.

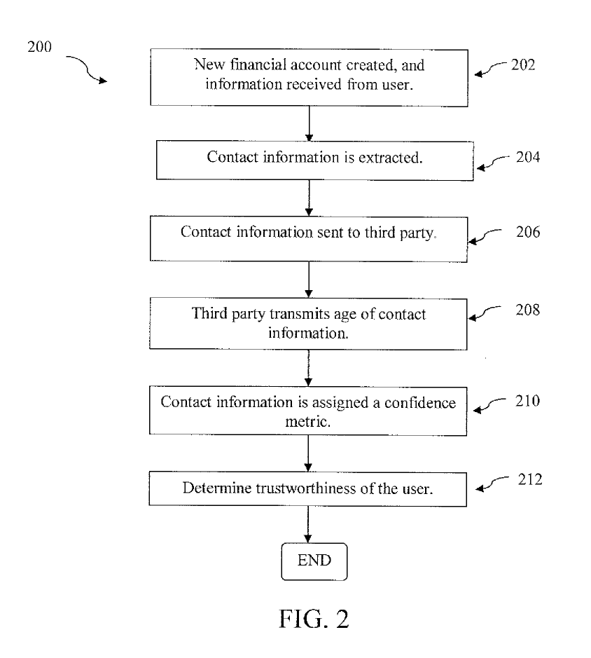

Referring now to FIG. 2 is a flowchart of a method 200 for determining trustworthiness of a user is illustrated according to an embodiment of the present disclosure. It should be appreciated that the method illustrated in the embodiment of FIG. 2 may be implemented by the system illustrated in FIG. 1 according to one or more embodiments.

The method 200 begins at step 202, where a new financial account is created by user 102 by entering contact information into a form accessible by the user device 120 and/or by providing the contact information over the phone. In various other embodiments, the user 102 provides the contact information by mail or in person. In one embodiment, the new financial account is set up with a service provider, such as PayPal, Inc. of San Jose, Calif., USA. In another embodiment, the new financial account is set up with a financial institution (e.g., a bank). In either embodiment, the user 102 must input his or her name, address, telephone number, date of birth, email address, and social security number to apply for the new account. The new account is approved by the service provider or financial institution and the service provider or financial institution issues a line of credit to the user 102. The financial institution may send the user information to the service provider to determine whether the user 102 is trustworthy.

In step 204, contact information, e.g., the email address and/or phone number of user 102, is extracted from the other information by the service provider server 180. In step 206, the service provider server 180 sends the contact information to the third party server 130.

In step 208, the third party server 130 queries its database(s) to determine the age of the contact information and transmits the age back to the service provider server 180, Fraudsters typically create new email accounts and/or new phone accounts for new accounts they want to create, as reusing email accounts that have been used for fraud before may raise a red flag. Generally, fraudsters create these new email and/or phone accounts right before creating a new financial account or opening a credit line. Preliminary studies indicated that over half of the email addresses used to set up fraudulent accounts in PayPal's Bill Me Later® service were created within the same month as the credit line was opened. Around 45% were created the same day as the account was opened, and over 70% of the email accounts were created within 2 months of the account creation.

In step 210, based on the age of the contact information, the service provider server 180 assigns the contact information a confidence metric. In one embodiment, the confidence metric is scaled to reflect the relative risk of fraud. The confidence metric indicates the likelihood or probability that the user 102 is a fraudster. The confidence metric may be a numerical value (e.g., 0.2 out of a range of values between 0 and 1, where 1 indicates that the user has committed identity theft) or may be a qualitative description (e.g., “highly suspicious,” “slightly suspicious,” or “not suspicious”). For example, if the age of the contact information is less than a month old, the confidence metric assigned may be “very suspicious,” to indicate a very high probability that the user 102 is a fraudster. On the other hand, if the age of the contact information is determined to be 10 years old or older, the confidence metric assigned may be “not suspicious,” to indicate that there is a low probability that the user 102 is a fraudster. There may be as many or as few categories on the scale as desired, depending on the level of detail desired.

In some embodiments, a determination of whether the confidence metric exceeds or crosses a certain threshold is made. The threshold may be associated with the level of certainty that the user 102 is or is not a fraudster. If the confidence metric exceeds the threshold, the user 102 may be determined to be a fraudster or not a fraudster. For example, if the age of the contact information exceeds a threshold age, the user 102 may be determined to be an authentic user. In other embodiments, if the age fails to exceed a threshold age, the user 102 may be determined to be a fraudster.

While the age of the contact information may be sufficient to determine the confidence metric, more information may be used to determine with increasing probability that the user is or is not a fraudster. In some embodiments, other information may be combined with the age of the contact information to provide a greater degree of certainty that the user is a fraudster or that he or she is authentic. Such information may include, for example, information from other credit applications and other identity records sharing common identity-related information with the user 102, voice biometrics, length of stay at an address, etc.

In one embodiment, the level of interaction between the user 102 and his or her accounts or contact points is examined. Sophisticated fraudsters know how to create many accounts (e.g., email accounts, phone accounts, financial accounts, etc.) and let them sit until they have aged. One way to still identify these fraudulent accounts is to determine the level of interaction that the user 102 has with these accounts. A fraudster will have very little interaction with the accounts since the accounts were created solely to provide a point of contact for identity theft. A legitimate user, on the other hand, will use the accounts to send and receive emails, make and receive phone calls, make and receive payments, etc.

Proceeding to step 212, based on the confidence metric assigned, the service provider server 180 determines the trustworthiness of the user 102. For example, if the confidence metric assigned is “very suspicious,” then the user 102 may be determined to be untrustworthy. In contrast, if the confidence metric assigned is “not suspicious,” then the user 102 may be determined to be trustworthy.

In one embodiment, the confidence metric and/or trustworthiness of the user 102 is used to determine the scope of transactions that can be performed by the user 102 with the new financial account. For example, if the confidence metric assigned to the contact information is “very suspicious,” transactions that carry a high degree of risk (e.g, a high dollar amount, luxury goods, etc.) may be prohibited. On the other hand, transactions that carry a lower degree of risk (e.g., low dollar amounts) will be allowed.

In one embodiment, the service provider server 180 receives financial transaction information when user 102 attempts to use his or her credit line. The transaction information may include information about the seller such as the seller's contact information, namely email address, user name, mailing address, as well as the seller's specified financial account. That is, the financial account to which the sale will eventually be credited when the sale is complete. The transaction information may also include information about the buyer, e.g., user 102, such as the buyer's billing and shipping address information, the buyer's telephone number(s), the buyer's email address, the buyer's user name, and the financial account the buyer has selected to use to pay for the transaction. In addition, the transaction information may include the price of the good(s) and/or service(s) and a description of the good(s) and/or service(s).

The service provider server 180 may look up the confidence metric assigned to the contact information of the buyer and determine whether or not to process the transaction. The service provider server 180 may completely block the transaction in some instances. In some embodiments, the service provider server 180 examines the transaction and anticipates the severity of possible fraud. Each type of transaction may be assigned a severity in accordance with the risk it poses. The severity level may be based on, for example, how much time would need to be spent to remediate fraud, how much money would potentially be lost, and/or how badly the credit worthiness of the actual user would be damaged. A severity may be assigned to the transaction, and the decision on whether or not to process the transaction may further depend on the assigned severity. High, moderate, or low risk transactions may be subject to further analysis.

In one embodiment, the confidence metric may be re-assigned after a certain amount of time has passed. The confidence metric is dynamic and changes over time. A confidence metric may reflect a snapshot of an identity theft risk at a particular moment in time, and may be later modified by other events or factors. For example, as the contact information of a user 102 grows older, and as the user 102 demonstrates trustworthiness in the handling of his or her financial account, the confidence metric may be changed to reflect a higher degree of trustworthiness and authenticity. In some embodiments, at certain milestones, certain limits on transactions and dollar amounts may be lifted. For example, the age of the user 102's email address may be periodically evaluated to determine whether the scope of allowed transactions should be broadened. For example, after 2 years, the service provider may determine to lift spending limits or allow higher amount payments.

The present disclosure describes systems and methods to detect and prevent identity theft and transaction fraud without compromising privacy. The user 102 is not contacted and asked to provide identifying information. Instead, information that has already been given is used. The age of the user 102's contact information is used as an indicator of accounts that are likely associated with identity theft. Credit bureaus and other entities can use the age of the contact information as a major measure of trust in the account's legitimacy. In addition, the level of interaction between the user 102 and his or her contact points or accounts (e.g., email accounts, phone accounts, financial accounts, etc.) may be determined as an added layer of security.

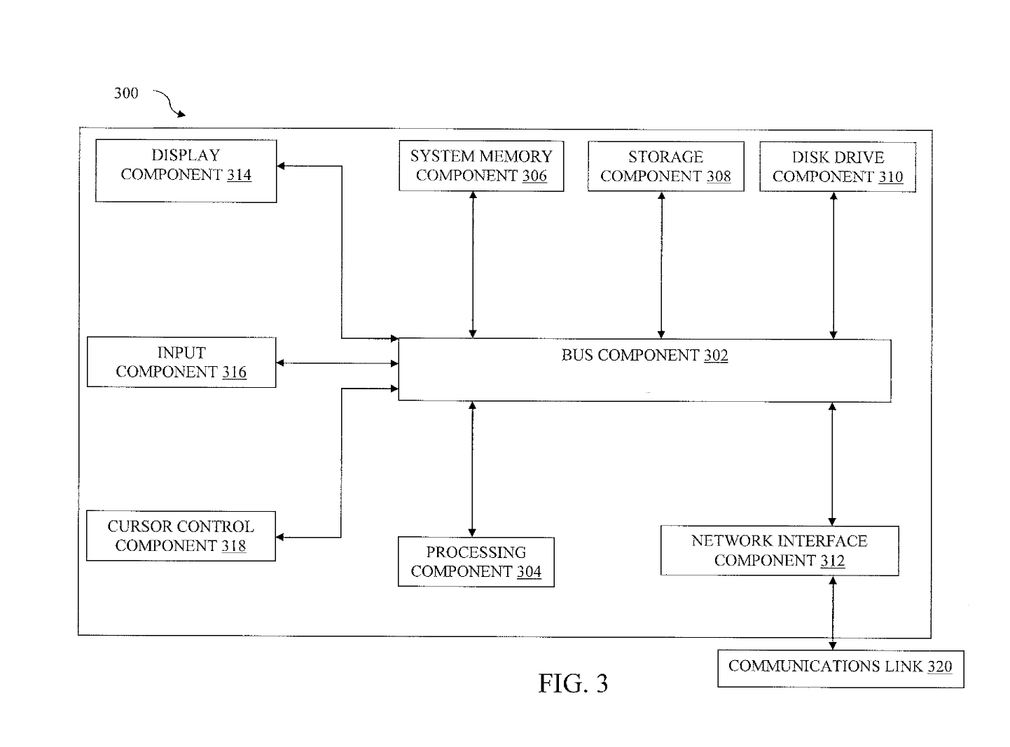

Referring now to FIG. 3, a block diagram of a system 300 is illustrated suitable for implementing embodiments of the present disclosure, including user device 120, third party server 130, and service provider server 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to collect and compare identifying characteristic information, present user preferences, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

Although various components and steps have been described herein as being associated with user device 120, third party server 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although financial transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system, comprising:
a memory device storing user account information, wherein the user account information comprises user financial account information; and
one or more processors in communication with the memory device and operable to:
receive information provided by a user to set up a new financial account;
extract contact information from the received information;
transmit the contact information to a third party to determine an age of the contact information;
receive the age of the contact information;
based on the age, assign a confidence metric, wherein the confidence metric is associated with the trustworthiness of the user.

2. The system of claim 1, wherein the contact information comprises an email address and/or phone number.

3. The system of claim 1, wherein the one or more processors is further operable to determine a scope of allowed transactions for the user.

4. The system of claim 3, wherein the one or more processors is further operable to receive transaction information.

5. The system of claim 4, wherein the transaction information comprises a price and/or a description of a good and/or service.

6. The system of claim 1, wherein the one or more processors is further operable to re-assign a confidence metric and determine a scope of allowed transactions for the user based on the re-assigned confidence metric.

7. The system of claim 1, wherein the one or more processors is further operable to receive or determine information regarding a level of interaction between the user and one or more user accounts.

8. A method for determining trustworthiness of a user, comprising:
receiving information, by one or more hardware processors of a service provider, provided by the user to set up a new financial account;
extracting contact information from the received information;
transmitting the contact information to a third party to determine an age of the contact information;
receiving the age of the contact information;
based on the age, assigning a confidence metric, by one or more hardware processors of a service provider, wherein the confidence metric is associated with the trustworthiness of the user.

9. The method of claim 9, wherein the contact information comprises an email address and/or phone number.

10. The method of claim 9, further comprising determining a scope of allowed transactions for the user.

11. The method of claim 10, further comprising receiving transaction information.

12. The method of claim 11, wherein the transaction information comprises a price and/or a description of a good and/or service.

13. The method of claim 8, further comprising re-assigning a confidence metric and determining a scope of allowed transactions for the user based on the re-assigned confidence metric.

14. The method of claim 8, further comprising receiving or determining information regarding a level of interaction between the user and one or more user accounts.

15. A non-transitory machine-readable medium comprising a plurality of machine-readable instructions which, when executed by one or more processors, are adapted to cause the one or more processors to perform a method comprising:
receiving information provided by a user to set up a new financial account;
extracting contact information from the received information;
transmitting the contact information to a third party to determine an age of the contact information;
receiving the age of the contact information;
based on the age, assigning a confidence metric, wherein the confidence metric is associated with the trustworthiness of the user.

16. The non-transitory machine-readable medium of claim 15, wherein contact information comprises an email address and/or phone number.

17. The non-transitory machine-readable medium of claim 15, wherein the method further comprises determining a scope of allowed transactions for the user.

18. The non-transitory machine-readable medium of claim 17, wherein the method further comprises receiving transaction information.

19. The non-transitory machine-readable medium of claim 15, wherein the method further comprises re-assigning a confidence metric and determining a scope of allowed transactions for the user based on the re-assigned confidence metric.

20. The non-transitory machine-readable medium of claim 19, wherein the method further comprises receiving or determining information regarding a level of interaction between the user and one or more user accounts.
